(19) United States
(12) Patent Application Publication
(10) Pub. No.: US 2016/0107286 A1
(43) Pub. Date: Apr. 21, 2016

(54) CMP POLISHING SOLUTION AND POLISHING METHOD USING SAME

(71) Applicant: HITACHI CHEMICAL COMPANY, LTD., Tokyo (JP)

(72) Inventors: Masahiro SAKASHITA, Chiyoda-ku, Tokyo (JP); Masayuki HANANO, Chiyoda-ku, Tokyo (JP); Kouji MISHIMA, Chiyoda-ku, Tokyo (JP)

(21) Appl. No.: 14/786,928

(22) PCT Filed: Apr. 24, 2014
(86) PCT No.: PCT/JP2014/061599

§ 371 Date: Oct. 23, 2015

(30) Foreign Application Priority Data
Apr. 25, 2013 (JP) 2013-092316
May 31, 2013 (JP) 2013-115361
Oct. 17, 2013 (JP) 2013-216229

(51) Int. Cl. B24B 37/04; C09G 1/02

(52) U.S. Cl. CPC B24B 37/044; C09G 1/02

(57) ABSTRACT

A CMP polishing liquid for polishing a ruthenium-based metal, comprising polishing particles, an acid component, an oxidizing agent, a triazole-based compound, a quaternary phosphonium salt and water, wherein the acid component contains at least one selected from the group consisting of inorganic acids, monocarboxylic acids, carboxylic acids having a plurality of carboxyl groups and having no hydroxyl group, and salts thereof, the polishing particles have a negative zeta potential in the CMP polishing liquid, and the pH of the CMP polishing liquid is 3.0 or more and less than 7.0.

### TECHNICAL FIELD

The present invention relates to a CMP polishing liquid for polishing a ruthenium-based metal and a polishing method using the same.

### BACKGROUND ART

New microfabrication techniques have been developed recently with higher integration and enhanced performance of semiconductor integrated circuits (LSI). A chemical mechanical polishing (hereinafter, referred to as “CMP”) method is one of the techniques, which is frequently used in steps of manufacturing LSIs, particularly in planarization of interlayer insulating materials, formation of metal plugs, formation of embedded wirings, and the like in multilayer wiring forming steps.

Recently, a damascene method for forming damascene wirings is mainly used for increasing the integration of LSIs and enhancing the performance of LSIs. An example of the damascene method will be described using FIG. 1. First, trench portions (depressed portions) 2 are formed on the surface of an insulating material 1 (FIGS. 1(a) and 1(b)). Next, a wiring metal 3 is deposited to embed the trench portions 2 (FIG. 1(c)). At this time, as shown in FIG. 1(c), depressions and projections are formed on the surface of the wiring metal 3 due to influences of the depressions and projections of the insulating material 1. Finally, the wiring metal 3 excluding the part embedded in the trench portions 2 is removed by CMP (FIG. 1(d)).

As the wiring metal (metal for a wiring portion), copper-based metals (such as copper and copper alloys) are often used. The copper-based metal may be diffused into the insulating material. To prevent this diffusion, a barrier metal in the form of a layer is disposed between the copper-based metal and the insulating material. As the barrier metal, tantalum-based metals and titanium-based metals are used, for example. However, these barrier metals have low adhesion to the copper-based metal. For this reason, generally, a copper-based metal thin film called a seed layer (copper seed layer) is disposed, and a copper-based metal is deposited thereon, rather than directly forming a wiring portion on the barrier metal, to keep the adhesion between the copper-based metal and the barrier metal. Namely, as shown in FIG. 2, a substrate (base), including an insulating material 1 having depressed portions on the surface thereof, a barrier metal 4 disposed on the insulating material 1 so as to follow the shape of the surface of the insulating material 1, a seed layer 5 disposed on the barrier metal 4 so as to follow the shape of the barrier metal 4, and a wiring metal 3 disposed on the seed layer 5 so as to embed depressed portions and cover the entire surface of the seed layer, is used.

A physical vapor deposition method (hereinafter, referred to as the “PVD method”) may be used in formation of the barrier metal 4 and the seed layer 5. However, in the PVD method, it is likely that a metal (barrier metal or seed layer) 6 formed on the inner walls of the trench portions by the PVD method has a partially increased thickness in the vicinity of the openings of the trench portions (depressed portions) formed in an insulating material 1, as shown in FIG. 3(a). In this case, as microfabrication of the wiring is progressed, the metals disposed on the inner walls of the trench portion are in contact with each as shown in FIG. 3(b), remarkably generating hollows (voids) 7.

As a solution to this problem, approaches using a ruthenium-based metal having high adhesion to the copper-based metal have been examined. Namely, an approach using a ruthenium-based metal as a seed layer instead of a copper-based metal or an approach disposing a ruthenium-based metal between a seed layer using a copper-based metal and a barrier metal have been proposed. The ruthenium-based metal can be formed by a chemical vapor deposition method (hereinafter, referred to as the “CVD method”) or an atomic layer deposition method (hereinafter, referred to as the “ALD method”). The CVD method or the ALD method can readily prevent generation of hollows and can be used for formation of microwirings.

If the ruthenium-based metal is used, part of the ruthenium-based metal needs to be removed by CMP in the step of forming damascene wirings. In contrast, several methods of polishing noble metals have been proposed. For example, a method of polishing a noble metal such as platinum, iridium, ruthenium, rhenium, rhodium, palladium, silver, osmium, or gold using a polishing liquid comprising polishing particles and at least one additive selected from the group consisting of diketone, heterocyclic compounds, urea compounds, and amphoteric compounds has been proposed (for example, see Patent Literature 1 below). Moreover, a method of polishing a noble metal with a chemical mechanical polishing system comprising a polishing material, a liquid carrier, and a sulfonic compound or a salt thereof has been proposed (for example, see Patent Literature 2 below).

### CITATION LIST

### Patent Literature

Patent Literature 1: U.S. Pat. No. 6,527,622

Patent Literature 2: Japanese Unexamined Patent Application Publication No. 2006-519490

### SUMMARY OF INVENTION

### Technical Problem

However, in the conventional CMP polishing liquids for a copper-based metal and the conventional CMP polishing liquids for a barrier metal, because the CMP polishing liquids are not specialized in removal of the ruthenium-based metal, a sufficient polishing rate of the ruthenium-based metal has not been attained. For this reason, an increase in the polishing rate of the ruthenium-based metal has been desired for the CMP polishing liquid, compared to the conventional CMP polishing liquids.

Furthermore, the present inventor has found the following knowledge. If a ruthenium-based metal is used in the damascene method, a wiring metal is exposed to the CMP polishing liquid during the step of removing the ruthenium-based metal by polishing. At this time, if the CMP polishing liquid comprises an oxidizing agent and/or the pH of the CMP polishing liquid is low, the wiring metal may be excessively etched to generate dishing (phenomenon that recess is formed in the cross section like a dish) in wiring portions. If such dishing is generated, wiring resistance is readily increased or electromigration readily occurs. In this case, since the reliability of devices may be reduced, it is preferred that generation of dishing be prevented as much as possible.

The present invention provides a CMP polishing liquid which can increase the polishing rate of a ruthenium-based metal and can prevent the dishing of a wiring metal, compared to the cases where the conventional CMP polishing liquid is used, and a polishing method using the same.

### Solution to Problem

The present inventor has inferred the reason why dishing is generated in the wiring metal as follows. Namely, it can be thought that the wiring metal is readily etched by influences of an oxidizing agent or the pH because the etching rate and the polishing rate of the wiring metal (such as a copper-based metal) tend to be high in the presence of the conventional CMP polishing liquid, and that this is the cause of dishing.

The present inventor, who has conducted extensive research based on such observation, has found that a ruthenium-based metal can be polished at a high rate and the dishing of a wiring metal can be prevented by using CMP polishing comprising polishing particles having a negative zeta potential in a CMP polishing liquid, a specific acid component, an oxidizing agent, a triazole-based compound, and a quaternary phosphonium salt and having a specific pH.

The CMP polishing liquid according to the present invention is a CMP polishing liquid for polishing a ruthenium-based metal, comprising polishing particles, an acid component, an oxidizing agent, a triazole-based compound, a quaternary phosphonium salt, and water, wherein the acid component contains at least one selected from the group consisting of inorganic acids, monocarboxylic acids, carboxylic acids having a plurality of carboxyl groups and no hydroxyl group, and salts thereof, the polishing particles have a negative zeta potential in the CMP polishing liquid, and the pH of the CMP polishing liquid is 3.0 or more and less than 7.0.

The CMP polishing liquid according to the present invention can increase the polishing rate of the ruthenium-based metal compared to the cases where the conventional CMP polishing liquid is used. The CMP polishing liquid according to the present invention can prevent the dishing of the wiring metal because the etching rate and the polishing rate of the wiring metal are suppressed compared to the cases where the conventional CMP polishing liquid is used.

It is preferred that the triazole-based compound contain a compound represented by the following general formula (I). Thereby, the polishing rate of the ruthenium-based metal is readily increased and the dishing of the wiring metal is readily prevented.

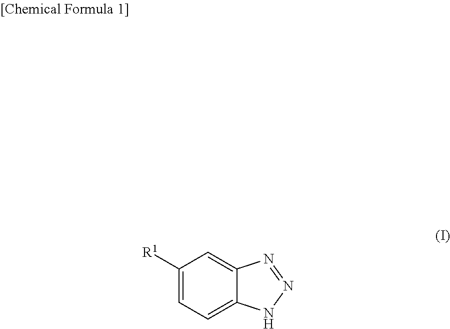

[In formula (I), R¹ represents a hydrogen atom or an alkyl group having 1 to 3 carbon atoms.]

It is preferred that the triazole-based compound contain 1,2,4-triazole. Thereby, the polishing rate of the ruthenium-based metal is readily increased and the dishing of the wiring metal is readily prevented.

It is preferred that the acid component contain at least one selected from the group consisting of nitric acid, phosphoric acid, glycolic acid, lactic acid, glycine, alanine, salicylic acid, acetic acid, propionic acid, fumaric acid, itaconic acid, maleic acid, and salts thereof Thereby, a practical polishing rate can be readily kept.

It is preferred that the quaternary phosphonium salt contain at least one selected from the group consisting of triaryl phosphonium salts and tetraaryl phosphonium salts. Thereby, the dishing of the wiring metal can be further prevented.

It is preferred that the quaternary phosphonium salt contain a compound represented by the following general formula (II). Thereby, the dishing of the wiring metal can be further prevented.

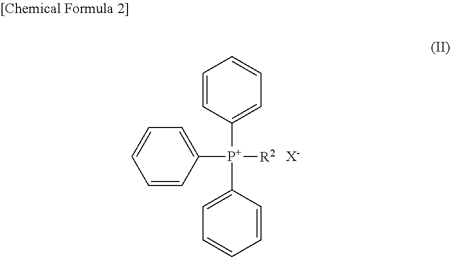

[In formula (II), benzene rings each may have a substituent; R² represents an optionally substituted alkyl or aryl group; and X⁻ represents an anion.]

The CMP polishing liquid according to the present invention may be a CMP polishing liquid for polishing a ruthenium-based metal and a wiring metal, and may be a CMP polishing liquid for polishing in which the amount of dishing of the wiring portion having a width of 1 μm and including the wiring metal is 30 nm or less.

The CMP polishing liquid according to the present invention can be stored, transported, and used in the form of a plurality of separate liquids of components forming the CMP polishing liquid. Specifically, the CMP polishing liquid according to the present invention may be separately stored in the form of a first liquid and a second liquid, wherein the first liquid contains the polishing particles, the acid component, the triazole-based compound and the quaternary phosphonium salt, and the second liquid contains the oxidizing agent. Thereby, the oxidizing agent can be prevented from decomposing during storage and stable polishing properties can be attained.

The polishing method according to the present invention comprises a polishing step of polishing a base having a ruthenium-based metal using the CMP polishing liquid to remove at least part of the ruthenium-based metal. Such a polishing method can increase the polishing rate of the ruthenium-based metal and can prevent the dishing of the wiring metal, compared to the cases where the conventional CMP polishing liquid is used.

The polishing method according to the present invention may be an aspect in which the base further has a wiring metal, and in the polishing step, at least part of the ruthenium-based metal and at least part of the wiring metal are removed. In the polishing method according to the present invention, it is preferred that the wiring metal contain a copper-based metal. These polishing methods can sufficiently utilize the properties of the CMP polishing liquid to increase the polishing rate of the ruthenium-based metal, and to prevent the dishing of the wiring metal.

The polishing method according to the present invention may further comprise a step of forming a ruthenium-based metal on a base by a formation method other than a PVD method to prepare a base having a ruthenium-based metal. The formation method may be at least one selected from the group consisting of CVD methods and ALD methods.

### Advantageous Effects of Invention

According to the present invention, the polishing rate of at least ruthenium-based metal can be increased and the dishing of the wiring metal can be prevented, compared to the cases where the conventional CMP polishing liquid is used. The present invention can provide applications (use) of the CMP polishing liquid to polishing of bases having ruthenium-based metals. Moreover, the present invention can provide applications (use) of the CMP polishing liquid to polishing of bases having ruthenium-based metals and wiring metals.

### BRIEF DESCRIPTION OF DRAWINGS

FIG. 1 is a schematic cross-sectional view illustrating a damascene method of forming damascene wirings.

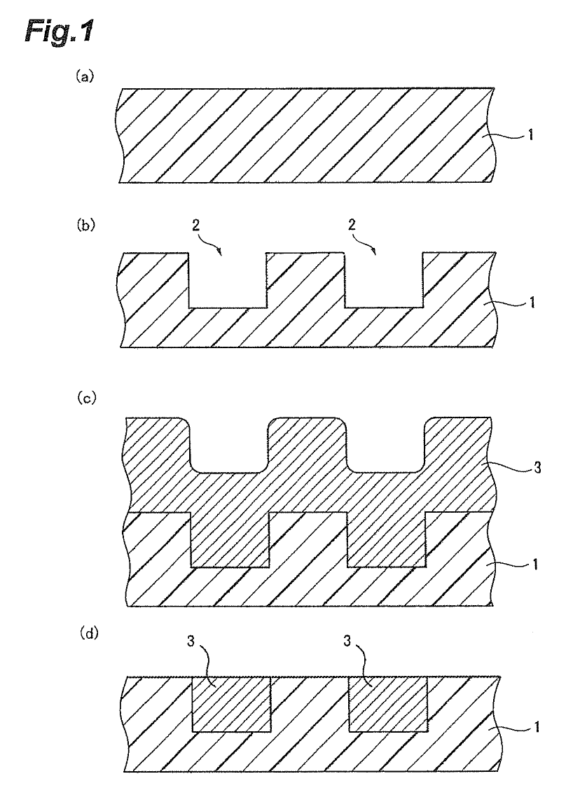

FIG. 2 is a schematic cross-sectional view illustrating a substrate having a seed layer disposed between a copper-based metal and a barrier metal.

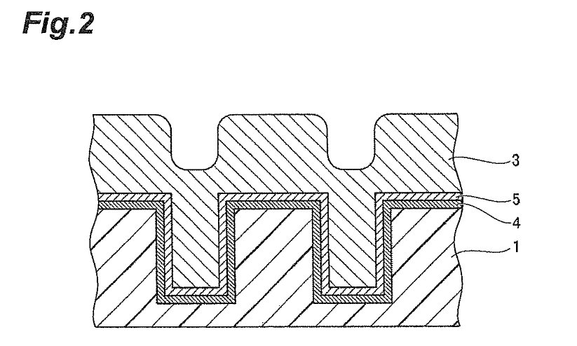

FIG. 3 is a schematic cross-sectional view illustrating a state of a metal formed by a PVD method.

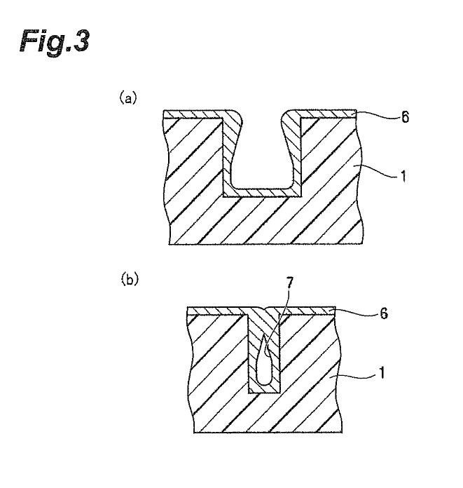

FIG. 4 is a schematic cross-sectional view illustrating a substrate having a ruthenium-based metal disposed instead of a copper seed layer.

FIG. 5 is a schematic cross-sectional view illustrating a substrate having a ruthenium-based metal disposed between a copper seed layer and a barrier metal.

FIG. 6 is a schematic cross-sectional view illustrating a step of polishing a base using a CMP polishing liquid.

### DESCRIPTION OF EMBODIMENTS

Embodiments of the present invention will hereinafter be described in detail. Throughout this specification, the numeric value range indicated using “to” indicates a range including numeric values written before and after “to” as the minimum value and the maximum value. Moreover, if a plurality of substances corresponding to a component in a composition is present, the content of the component in the composition indicates the total amount of the plurality of substances present in the composition, unless otherwise specified.

<CMP Polishing Liquid>

The CMP polishing liquid according to the present embodiment is a CMP polishing liquid for polishing a ruthenium-based metal. The CMP polishing liquid according to the present embodiment comprises (a) polishing particles (abrasive particles) having a negative zeta potential in the CMP polishing liquid, (b) an acid component containing at least one selected from the group consisting of inorganic acids, monocarboxylic acids, carboxylic acids having a plurality of carboxyl groups and having no hydroxyl group, and salts thereof, (c) an oxidizing agent, (d) a triazole-based compound, (e) a quaternary phosphonium salt and (f) water. The pH of the CMP polishing liquid according to the present embodiment is 3.0 or more and less than 7.0.

The components forming the CMP polishing liquid and the like will hereinafter be described.

(Polishing Particles)

Generally, polishing particles have predetermined hardness, and therefore the mechanical action attributed to the hardness contributes to progression of polishing The polishing particles used in the CMP polishing liquid according to the present embodiment have a negative (minus) zeta potential in the CMP polishing liquid having a pH of 3.0 or more and less than 7.0 (namely, zeta potential is less than 0 mV). Thereby, the polishing rate of the ruthenium-based metal is increased. Although the reason for this is not clear, it can be thought that the polishing particles having a negative zeta potential generate interaction between the polishing particles and the ruthenium-based metal due to electrostatic attraction to increase the polishing rate of the ruthenium-based metal.

From the viewpoint that such an effect is more significantly attained, the zeta potential is preferably −2 mV or less, more preferably −5 mV or less, further preferably −10 mV or less, particularly preferably −15 mV or less, extremely preferably −20 mV or less. From the viewpoint that the polishing particles repel each other to prevent aggregation of the polishing particles, it is preferred that the absolute value of the zeta potential be large (namely, separate from 0 mV).

The zeta potential can be measured with a product name DELSA NANO C manufactured by Beckman Coulter, Inc., for example. The zeta potential (ζ [mV]) can be measured according to the following procedure. First, the CMP polishing liquid is diluted with pure water such that the scattering intensity of the sample for measurement with a zeta potential measurement apparatus is 1.0×10⁴ to 5.0×10⁴ cps (where “cps” indicates counts per second, which is a unit of the number of particles counted), to obtain a sample. Then, the sample is placed in a cell for measuring the zeta potential to measure the zeta potential. To adjust the scattering intensity within the range, the CMP polishing liquid is diluted such that the content of the polishing particles is 1.7 to 1.8% by mass, for example.

The polishing particles are not limited in particular as long as the surface potential (zeta potential) in the CMP polishing liquid is negative; at least one selected from the group consisting of silica, alumina, zirconia, ceria, titania, germania, and modified products thereof is preferred.

Among the polishing particles, silica and alumina are preferred, colloidal silica and colloidal alumina are more preferred, and colloidal silica is further preferred from the viewpoint that the dispersion stability in the CMP polishing liquid is high and the number of polishing flaws (scratches) generated by CMP is small.

The zeta potential can vary according to the pH of the CMP polishing liquid described later. For this reason, if the polishing particles have a positive zeta potential in the CMP polishing liquid, the zeta potential of the polishing particles can be adjusted to be negative, for example, by applying a known method such as reforming of the surfaces of the polishing particles. Examples of such polishing particles include polishing particles of silica, alumina, zirconia, ceria, titania, or germania having their surfaces modified with a sulfo group or aluminate.

The upper limit of the average particle size of the polishing particles is preferably 200 nm or less, more preferably 100 nm or less, further preferably 80 nm or less from the viewpoint that the dispersion stability in the CMP polishing liquid is high and the number of polishing flaws generated by CMP is small. The lower limit of the average particle size of the polishing particles is not limited in particular; it is preferably 1 nm or more. Moreover, the lower limit of the average particle size of the polishing particles is more preferably 10 nm or more, further preferably 20 nm or more, particularly preferably 30 nm or more, extremely preferably 40 nm or more from the viewpoint that the polishing rate of the ruthenium-based metal is readily increased.

The “average particle size” of the polishing particles indicates the average secondary particle diameter of the polishing particles. The average particle size indicates the D50 value (median size in volume distribution, cumulative median value) determined by measuring the CMP polishing liquid with a dynamic light scattering particle size distribution analyzer (such as product name COULTER N4 SD manufactured by COULTER Electronics, Inc.).

Specifically, the average particle size can be measured according to the following procedure. First, about 100 μL (L represents litter. The same is true below) of the CMP polishing liquid is weighed, and is diluted with deionized water such that the content of the polishing particles is around 0.05% by mass (where transmittance (H) is 60 to 70% in measurement of the content) to obtain a diluted liquid. The diluted liquid is then placed in a sample tank of the dynamic light scattering particle size distribution analyzer, and the value displayed as D50 is read to measure the average particle size.

The content of the polishing particles is preferably 1.0% by mass or more, more preferably 5.0% by mass or more, further preferably 10.0% by mass or more based on the total mass of the CMP polishing liquid from the viewpoint that a favorable polishing rate of the ruthenium-based metal is readily attained. The content of the polishing particles is preferably 50.0% by mass or less, more preferably 30.0% by mass or less, further preferably 20.0% by mass or less based on total mass of the CMP polishing liquid from the viewpoint that the generation of polishing flaws is readily prevented.

(Acid Component)

The CMP polishing liquid according to the present embodiment comprises an acid component containing at least one selected from the group consisting of inorganic acid components (such as inorganic acids and inorganic acid salts) and organic acid components (such as organic acids and organic acid salts), specifically comprises an acid component containing at least one selected from the group consisting of inorganic acids, monocarboxylic acids (carboxylic acids having one carboxyl group), carboxylic acids having a plurality of carboxyl groups and having no hydroxyl group, and salts thereof to increase the polishing rate of the ruthenium-based metal. It can be thought that the specific acid component is reacted with the ruthenium-based metal to form a complex, and therefore, a high polishing rate of the ruthenium-based metal can be attained. If the base to be polished has a barrier metal other than the ruthenium-based metal, and the like, the specific acid component can also increase the polishing rate of such a metal.

Examples of the inorganic acid components include nitric acid, phosphoric acid, hydrochloric acid, sulfuric acid, chromic acid, and salts thereof. As the inorganic acid components, at least one selected from the group consisting of nitric acid, phosphoric acid, and salts thereof is preferred, nitric acid, phosphoric acid, and phosphates are more preferred, nitric acid and phosphoric acid are further preferred, and phosphoric acid is particularly preferred from the viewpoint that a practical polishing rate is readily kept. Examples of the inorganic acid salts include ammonium salts. Examples of ammonium salts include ammonium nitrate, ammonium phosphate, ammonium chloride, and ammonium sulfate.

The organic acid component can be a compound corresponding to any of monocarboxylic acid, carboxylic acids having a plurality of carboxyl groups and having no hydroxyl group, and salts thereof, and may be any of hydroxy acid, carboxylic acid (such as monocarboxylic acid and dicarboxylic acid), amino acid, a pyran compound, a ketone compound, and the like. As the organic acid component, at least one selected from the group consisting of hydroxy acids, monocarboxylic acids, and dicarboxylic acids is preferred, and hydroxy acids are more preferred from the viewpoint that a practical polishing rate is readily kept. Moreover, the organic acid component may be any of saturated carboxylic acids, unsaturated carboxylic acids, aromatic carboxylic acids, and the like.

Examples of the monocarboxylic acids include glycolic acid, lactic acid, glycine, alanine, salicylic acid, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, and glyceric acid. Examples of the carboxylic acids having a plurality of carboxyl groups and having no hydroxyl group include fumaric acid, itaconic acid, maleic acid, oxalic acid, malonic acid, succinic acid, glutaric acid, adipic acid, pimelic acid, and phthalic acid. Examples of the organic acid salts include ammonium salts. Examples of the ammonium salts include ammonium acetate.

As the organic acid component, from the viewpoint that a practical polishing rate is readily kept, at least one selected from the group consisting of glycolic acid, lactic acid, glycine, alanine, salicylic acid, acetic acid, propionic acid, fumaric acid, itaconic acid, maleic acid, and salts thereof is preferred, and at least one hydroxy acid selected from the group consisting of glycolic acid, lactic acid, and salicylic acid is more preferred.

As the acid component, at least one selected from the group consisting of nitric acid, phosphoric acid, glycolic acid, lactic acid, glycine, alanine, salicylic acid, acetic acid, propionic acid, fumaric acid, itaconic acid, maleic acid, and salts thereof is preferred from the viewpoint that a practical polishing rate is readily kept.

The acid component may be used singly or in combinations of two or more.

The content of the acid component is preferably 0.01% by mass or more, more preferably 0.1% by mass or more, further preferably 0.2% by mass or more, particularly preferably 0.3% by mass or more based on the total mass of the CMP polishing liquid from the viewpoint that the polishing rate of the ruthenium-based metal is readily increased. From the same viewpoint and from the viewpoint that high stability of the polishing liquid is attained, the content of the acid component is preferably 1.0% by mass or less, more preferably 0.7% by mass or less, further preferably 0.5% by mass or less based on the total mass of the CMP polishing liquid.

(Oxidizing Agent)

The CMP polishing liquid according to the present embodiment comprises an oxidizing agent for a metal (hereinafter simply referred to as “oxidizing agent”). As the oxidizing agent, a compound corresponding to the acid component above is excluded.

Examples of the oxidizing agent include, but should not be limited to, hydrogen peroxide, hypochlorous acid, ozone water, periodic acid, periodates, iodates, bromates, persulfates, and cerium nitrate salts. From the viewpoint that the ruthenium moiety of the ruthenium-based metal is oxidized in an acidic solution to become trivalent, and therefore, the polishing rate of the ruthenium-based metal is further increased, hydrogen peroxide is preferred as the oxidizing agent. Hydrogen peroxide may be used in the form of a hydrogen peroxide solution. Examples of salts such as periodates, iodates, bromates, persulfates, and cerium nitrates include ammonium salts. The oxidizing agent may be used singly or in combinations of two or more.

The content of the oxidizing agent is preferably 0.001% by mass or more, more preferably 0.005% by mass or more, further preferably 0.01% by mass or more, particularly preferably 0.02% by mass or more, extremely preferably 0.03% by mass or more based on the total mass of the CMP polishing liquid from the viewpoint that the polishing rate of the ruthenium-based metal is further increased. The content of the oxidizing agent is preferably 50.0% by mass or less, more preferably 5.0% by mass or less, further preferably 1.0% by mass or less, particularly preferably 0.5% by mass or less, extremely preferably 0.1% by mass or less based on the total mass of the CMP polishing liquid from the viewpoint that the surface roughness is unlikely to be generated after polishing. For oxidizing agents usually available in the form of an aqueous solution, such as hydrogen peroxide solutions, the content of the oxidizing agent contained in the aqueous solution can be adjusted within the range above in the CMP polishing liquid.

(Triazole-Based Compound)

The CMP polishing liquid according to the present embodiment comprises a triazole-based compound as an anti-corrosion agent to increase the polishing rate of the ruthenium-based metal and prevent the dishing of the wiring metal. As the triazole-based compound, compounds known as anti-corrosion agents or protective film forming agents can be used without limitation.

Although factors to attain the effect of increasing the polishing rate of the ruthenium-based metal are not always clear, it is inferred that, when the CMP polishing liquid comprises the triazole-based compound, nitrogen atoms (N atoms) in the triazole-based compound are coordinated with the ruthenium-based metal to form a weak reaction layer, and therefore, the polishing rate of the ruthenium-based metal is increased. It is also inferred that the reaction layer, although fragile to mechanical action, can serve as a protective layer to chemical action, and therefore, an anti-corrosion effect on the wiring metal (dishing preventing effect) is readily attained.

Examples of the triazole-based compound include compounds having skeletons such as 1,2,3-triazole, 1,2,4-triazole, 3-amino-1H-1,2,4-triazole, 1-hydroxybenzotriazole, 1-hydroxypropylbenzotriazole, 2,3-dicarboxypropylbenzotriazole, 4-hydroxybenzotriazole, 4-carboxyl(-1H-)benzotriazole, 4-carboxyl(-1H-)benzotriazole methyl ester, 4-carboxyl(-1H-)benzotriazole butyl ester, 4-carboxyl(-1H-)benzotriazole octyl ester, 5-hexylbenzotriazole, [1,2,3-benzotriazolyl-1-methyl][1,2,4-triazolyl-1-methyl][2-ethylhexyl] amine, benzotriazole, 5-methyl(-1H-)benzotriazole (another name: tolyltriazole), 5-ethyl(-1H-)benzotriazole, 5-propyl(-1H-)benzotriazole, naphthotriazole, and bis[(1-benzotriazolyl)methyl]phosphonic acid. The triazole-based compound may be used singly or in combinations of two or more.

As the triazole-based compound, a compound represented by the following general formula (I) is preferred. Thereby, the polishing rate of the ruthenium-based metal is readily increased and the dishing of the wiring metal is readily prevented. Although factors to attain such effects are not always clear, it is inferred that the compound represented by the general formula (I) is readily coordinated with the ruthenium-based metal among the triazole-based compounds, and therefore, the dishing of the wiring metal can be prevented while increasing the polishing rate of the ruthenium-based metal. Examples of the compound represented by the general formula (I) include benzotriazole, 5-methyl(-1H-)benzotriazole, 5-ethyl(-1H-)benzotriazole, and 5-propyl(-1H-)benzotriazole.

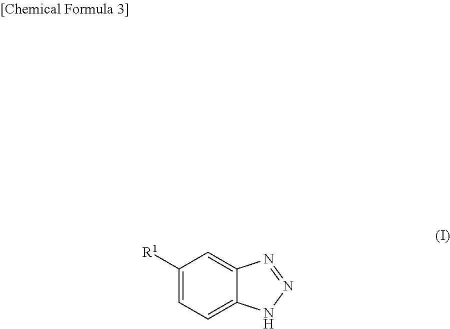

[In formula (I), R¹ represents a hydrogen atom or an alkyl group having 1 to 3 carbon atoms.]

Moreover, as the triazole-based compound, 1,2,4-triazole is preferred from the viewpoint that the polishing rate of the ruthenium-based metal is readily increased and the dishing of the wiring metal is readily prevented. Use of the compound represented by the general formula (I) in combination with 1,2,4-triazole further increases the polishing rate of the ruthenium-based metal. Namely, in the CMP polishing liquid according to the present embodiment, use of the compound represented by the general formula (I) in combination with 1,2,4-triazole is preferred. Although factors to attain such effects are not always clear, it is inferred that because 1,2,4-triazole is a compound readily coordinated with the ruthenium-based metal and readily dissolved in water among the triazole-based compounds, the ruthenium-based metal complex is more readily formed by use of the compound represented by the general formula (I) in combination with 1,2,4-triazole compared to the cases where these compounds are singly used, so that the polishing rate of the ruthenium-based metal can be increased. For example, the polishing rate of the ruthenium-based metal can be further increased by use of 5-methyl(-1H-)benzotriazole in combination with 1,2,4-triazole compared to the cases where the triazole-based compound is singly used.

The content of the compound represented by the general formula (I) is preferably 0.001% by mass or more, more preferably 0.01% by mass or more, further preferably 0.1% by mass or more, particularly preferably 0.2% by mass or more, extremely preferably 0.3% by mass or more based on the total mass of the CMP polishing liquid from the viewpoint that etching of the wiring metal is readily prevented and roughness of the polished surface is unlikely to be generated. The content of the compound represented by the general formula (I) is preferably 10.0% by mass or less, more preferably 5.0% by mass or less, further preferably 2.0% by mass or less, particularly preferably 1.0% by mass or less based on the total mass of the CMP polishing liquid from the viewpoint that the polishing rate of the barrier metal is unlikely to be reduced.

The content of the triazole-based compound is preferably 0.001% by mass or more, more preferably 0.01% by mass or more, further preferably 0.1% by mass or more based on the total mass of the CMP polishing liquid from the viewpoint that the polishing rate of the ruthenium-based metal is further increased. The content of the triazole-based compound is preferably 30.0% by mass or less, more preferably 10.0% by mass or less, further preferably 5.0% by mass or less based on the total mass of the CMP polishing liquid from the viewpoint that a reduction in the polishing rate of the ruthenium-based metal is readily prevented. If a plurality of compounds is used as the triazole-based compound, it is preferred that the total content of the compounds satisfy the range.

(Quaternary Phosphonium Salt)

The CMP polishing liquid according to the present embodiment comprises a quaternary phosphonium salt to prevent the dishing of the wiring metal by suppressing the etching rate and the polishing rate of the wiring metal. Although the reason why the quaternary phosphonium salt has an anti-corrosion effect (dishing preventing effect) on the wiring metal is not clear, it can be thought that phosphorus atoms in the quaternary phosphonium salt are coordinated with the wiring metal so that a hydrophobic group of the quaternary phosphonium salt covers the surface of the wiring metal.

As the quaternary phosphonium salt, at least one selected from the group consisting of triarylphosphonium salts and tetraarylphosphonium salts is preferred, and tetraarylphosphonium salts are more preferred, from the viewpoint that the dishing of the wiring metal is further prevented. In this case, because the aryl group bonded to the phosphorus atom has high hydrophobicity, the effect of hydrophobicity is readily attained based on 3 or 4 hydrophobic groups (aryl groups) bonded to the phosphorus atom, and therefore, the anti-corrosion effect on the wiring metal is readily attained.

Examples of substituents bonded to the phosphorus atom of the quaternary phosphonium salt include an aryl group, an alkyl group, and a vinyl group.

Examples of the aryl group bonded to the phosphorus atom include a phenyl group, a benzyl group, and a naphthyl group; a phenyl group is preferred.

The alkyl group bonded to the phosphorus atom may be a linear alkyl group or a branched alkyl group. It is preferred that for the chain length of the alkyl group, the following range is preferred based on the number of carbon atoms from the viewpoint that the mechanism is readily exhibited to further prevent the dishing of the wiring metal. The number of carbon atoms of the alkyl group is preferably 1 or more, more preferably 4 or more. The number of carbon atoms of the alkyl group is preferably 14 or less, more preferably 7 or less. If the number of carbon atoms of the alkyl group is 14 or less, the CMP polishing liquid tends to have high storage stability. The chain length is determined from the portion having the longest chain length.

Substituent such as a halogen group, a hydroxy group (hydroxyl group), a nitro group, a cyano group, an alkoxy group, a formyl group, an amino group (such as an alkylamino group), a naphthyl group, an alkoxy carbonyl group, and a carboxy group may be further bonded to the substituent bonded to the phosphorus atom. For example, an aryl group having a substituent may be a 2-hydroxybenzyl group, a 2-chlorobenzyl group, a 4-chlorobenzyl group, a 2,4-dichlorobenzyl group, a 4-nitrobenzyl group, a 4-ethoxybenzyl group, and a 1-naphthylmethyl group. The alkyl group having a substituent may be a cyanomethyl group, a methoxymethyl group, a formylmethyl group, a methoxycarbonylmethyl group, an ethoxycarbonylmethyl group, a 3-carboxypropyl group, a 4-carboxybutyl group, a 2-dimethylaminoethyl group, or the like. If the alkyl group is branched, a portion branched from the longest chain (portion not having the longest chain length) is defined as the substituent.

Examples of counter anions (negative ions) of quaternary phosphonium cations of the quaternary phosphonium salts include, but should not be limited to, halogen ions (such as F⁻, Cl⁻, Br, and I⁻), hydroxide ions, nitrate ions, nitrite ions, hypochlorite ions, chlorite ions, chlorate ions, perchlorate ions, acetate ions, hydrogen carbonate ions, phosphate ions, sulfate ions, hydrogen sulfate ions, sulfite ions, thiosulfate ions, and carbonate ions.

As the triarylphosphonium salts, alkyltriarylphosphonium salts (compounds having an alkyltriarylphosphonium salt structure) are preferred, and alkyltriphenylphosphonium salts are more preferred from the viewpoint that the dishing of the wiring metal is further prevented.

For the chain length of the alkyl group of the alkyltriarylphosphonium salt, the above range is preferred based on the number of carbon atoms from the viewpoint that the mechanism is readily exhibited to further prevent the dishing of the wiring metal.

The quaternary phosphonium salt preferably contain a compound represented by the following general formula (II).

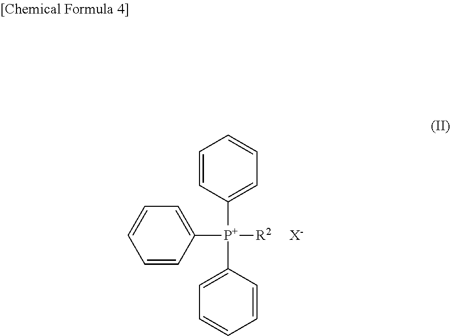

[In formula (II), benzene rings each may have a substituent; R² represents an optionally substituted alkyl or aryl group; and X⁻ represents an anion.]

Examples of the alkyl group and the aryl group of R² in the general formula (II) include the alkyl groups and aryl groups described above. As the alkyl group for R², alkyl groups having 14 or less carbon atoms are preferred from the viewpoint of high stability of the polishing liquid. Examples of the aryl group for R² include, but should not be limited to, a phenyl group and a methylphenyl group.

As the anion X⁻ in the formula (II), the counter anions described above as the counter anions of the quaternary phosphonium cations can be used. The anion X⁻ is not limited in particular; halogen ions are preferred, and bromonium ions are more preferred.

Specific examples of the quaternary phosphonium salt include methyltriphenylphosphonium salts, ethyltriphenylphosphonium salts, triphenylpropylphosphonium salts, isopropyltriphenylphosphonium salts, butyltriphenylphosphonium salts, pentyltriphenylphosphonium salts, hexyltriphenylphosphonium salts, n-heptyltriphenylphosphonium salts, triphenyl(tetradecyl)phosphonium salts, tetraphenylphosphonium salts, benzyltriphenylphosphonium salts, (2-hydroxybenzyl)triphenylphosphonium salts, (2-chlorobenzyl)triphenylphosphonium salts, (4-chlorobenzyl)triphenylphosphonium salts, (2,4-dichlorobenzyl)phenylphosphonium salts, (4-nitrobenzyl)triphenylphosphonium salts, 4-ethoxybenzyltriphenylphosphonium salts, (1-naphthylmethyl)triphenylphosphonium salts, (cyanomethyl)triphenylphosphonium salts, (methoxymethyl)triphenylphosphonium salts, (formylmethyl)triphenylphosphonium salts, acetonyltriphenylphosphonium salts, phenacyltriphenylphosphonium salts, methoxycarbonylmethyl(triphenyl)phosphonium salts, ethoxycarbonylmethyl(triphenyl)phosphonium salts, (3-carboxypropyl)triphenylphosphonium salts, (4-carboxybutyl)triphenylphosphonium salts, 2-dimethylaminoethyltriphenylphosphonium salts, triphenylvinylphosphonium salts, allyltriphenylphosphonium salts, and triphenylpropargylphosphonium salts. The quaternary phosphonium salt may be used singly or in combinations of two or more.

Among these, butyltriphenylphosphonium salts, pentyltriphenylphosphonium salts, hexyltriphenylphosphonium salts, n-heptyltriphenylphosphonium salts, tetraphenylphosphonium salts, and benzyltriphenylphosphonium salts are preferred from the viewpoint of high affinities for the wiring metal. As the salts thereof, bromonium salts and chloride salts are preferred.

The content of the quaternary phosphonium salt is preferably 0.0001% by mass or more, more preferably 0.001% by mass or more, further preferably 0.005% by mass or more based on the total mass of the CMP polishing liquid from the viewpoint that the effect of preventing the polishing rate of the wiring metal is effectively attained. The content of the quaternary phosphonium salt is preferably 0.1% by mass or less, more preferably 0.05% by mass or less, further preferably 0.01% by mass or less based on the total mass of the CMP polishing liquid from the viewpoint that the polishing rate of the wiring metal is further prevented and the CMP polishing liquid has high storage stability.

(Metal Solubilizing Agent)

The CMP polishing liquid according to the present embodiment can further comprise a metal solubilizing agent to increase the polishing rate of a metal material such as a barrier metal other than the ruthenium-based metal. Any compound reactive with the metal material to form a complex can be used as the metal solubilizing agent without limitation, however, compounds corresponding to the acid component above are excluded. Examples of the metal solubilizing agent include organic acids, such as malic acid, tartaric acid, and citric acid; organic acid esters of these organic acids; and ammonium salts of these organic acids.

Among these, preferred are malic acid, tartaric acid, and citric acid from the viewpoint that a practical CMP rate can be kept and excessive etching of the wiring metal is readily prevented. The metal solubilizing agent can be used singly or in combinations of two or more.

The content of the metal solubilizing agent is preferably 0.001% by mass or more, more preferably 0.01% by mass or more, further preferably 0.1% by mass or more based on the total mass of the CMP polishing liquid from the viewpoint of increasing the polishing rate of the metal material such as a barrier metal other than the ruthenium-based metal. The content of the metal solubilizing agent is preferably 20.0% by mass or less, more preferably 10.0% by mass or less, further preferably 5.0% by mass or less based on the total mass of the CMP polishing liquid from the viewpoint that etching is readily prevented and roughness of the polished surface is unlikely to be generated.

(Metal Anti-Corrosion Agent)

The CMP polishing liquid according to the present embodiment can further comprise a metal anti-corrosion agent (excluding the triazole-based compound) to prevent excessive polishing of the metal material such as a barrier metal other than the ruthenium-based metal, and a wiring metal.

Examples of the metal anti-corrosion agent include, but should not be limited to, compounds having a thiazole skeleton, compounds having a pyrimidine skeleton, compounds having a tetrazole skeleton, compounds having an imidazole skeleton, and compounds having a pyrazole skeleton.

Examples of the compounds having a thiazole skeleton include 2-mercaptobenzothiazole.

Examples of the compounds having a pyrimidine skeleton include pyrimidine, 1,2,4-triazolo[1,5-a]pyrimidine, 1,3,4,6,7,8-hexahydro-2H-pyrimido[1,2-a]pyrimidine, 1,3-diphenyl-pyrimidine-2,4,6-trione, 1,4,5,6-tetrahydropyrimidine, 2,4 5,6-tetraaminopyrimidine sulfate, 2,4,5-trihydroxypyrimidine, 2,4,6-triaminopyrimidine, 2,4,6-trichloropyrimidine, 2,4,6-trimethoxypyrimidine, 2,4,6-triphenylpyrimidine, 2,4-diamino-6-hydroxylpyrimidine, 2,4-diaminopyrimidine, 2-acetoamidepyrimidine, 2-aminopyrimidine, 2-methyl-5,7-diphenyl-(1,2,4)triazolo [1,5-a]pyrimidine, 2-methyl sulfanyl-5,7-diphenyl-(1,2,4)triazolo [1,5-a]pyrimidine, 2-methyl sulfanyl-5,7-diphenyl-4,7-dihydro-(1,2,4)triazolo [1,5-a]pyrimidine, and 4-aminopyrazolo[3,4-d]pyrimidine.

Examples of the compounds having a tetrazole skeleton include tetrazole, 5-methyltetrazole, 5-aminotetrazole, and 1-(2-dimethylaminoethyl)-5-mercaptotetrazole.

Examples of the compounds having an imidazole skeleton include imidazole, 2-methylimidazole, 2-ethylimidazole, 2-isopropylimidazole, 2-propylimidazole, 2-butylimidazole, 4-methylimidazole, 2,4-dimethylimidazole, 2-ethyl-4-methylimidazole, 2-undecylimidazole, and 2-aminoimidazole.

Examples of the compounds having a pyrazole skeleton include pyrazole, 3,5-dimethylpyrazole, 3-amino-5-methylpyrazole, 4-methylpyrazole, and 3-amino-5-hydroxypyrazole.

The metal anti-corrosion agent can be used singly or in combinations of two or more.

The content of the metal anti-corrosion agent is preferably 0.001% by mass or more, more preferably 0.005% by mass or more, further preferably 0.01% by mass or more based on the total mass of the CMP polishing liquid from the viewpoint that excessive etching of the wiring metal is readily prevented and roughness of the polished surface is unlikely to be generated. The content of the metal anti-corrosion agent is preferably 10.0% by mass or less, more preferably 5.0% by mass or less, further preferably 2.0% by mass or less based on the total mass of the CMP polishing liquid from the viewpoint that the polishing rate of the barrier metal is unlikely to be reduced.

(Water-Soluble Polymer)

The CMP polishing liquid according to the present embodiment can further comprise a water-soluble polymer. If the CMP polishing liquid comprises a water-soluble polymer, the exchange current density in the presence of a load can be increased and the exchange current density in the absence of a load can be reduced. This principle has not been clarified yet.

Examples of the water-soluble polymers include, but should not be limited to, polycarboxylic acids and salts thereof, such as poly(aspartic acid), poly(glutamic acid), polylysine, poly(malic acid), poly(methacrylic acid), ammonium polymethacrylate, sodium polymethacrylate, poly(amic acid), poly(maleic acid), poly(itaconic acid), poly(fumaric acid), poly(p-styrene carboxylate), poly(acrylic acid), poly(acrylamide), aminopoly(acrylamide), ammonium polyacrylate, sodium polyacrylate, polyamic acid ammonium salt, polyamic acid sodium salt, and poly(glyoxylic acid); polysaccharides, such as alginic acid, pectic acid, carboxy methyl cellulose, agar, curdlan, and pullulan; and vinyl-based polymers, such as poly(vinyl alcohol), poly(vinylpyrrolidone), poly-(4-vinylpyridine), and polyacrolein. The water-soluble polymer may be used singly or in combinations of two or more.

The lower limit of the weight average molecular weight of the water-soluble polymer is preferably 500 or more, more preferably 1500 or more, further preferably 5000 or more. At a weight average molecular weight of the water-soluble polymer of 500 or more, a high polishing rate of the barrier metal is readily attained. The weight average molecular weight of the water-soluble polymer can have any upper limit, and is preferably 5000000 or less from the viewpoint of high solubility. The weight average molecular weight of the water-soluble polymer can be measured under the following conditions by gel permeation chromatography (GPC) using calibration curves of standard polystyrenes.

<GPC Conditions>

Sample: 10 μL

Standard polystyrenes: manufactured by Tosoh Corporation, standard polystyrenes (molecular weight: 190000, 17900, 9100, 2980, 578, 474, 370, and 266)

Detector: manufactured by Hitachi, Ltd., RI-monitor, product name “L-3000”

Integrator: manufactured by Hitachi, Ltd., GPC integrator, product name “D-2200”

Pump: manufactured by Hitachi, Ltd., product name “L-6000”

Degassing apparatus: manufactured by Showa Denko K.K., product name “Shodex DEGAS” (“Shodex” is a registered trademark)

Columns: manufactured by Hitachi Chemical Company, Ltd., product names “GL-R440,” “GL-R430,” and “GL-R420” are connected in this order for use

Eluent: tetrahydrofuran (THF)

Temperature for measurement: 23° C.

Flow rate: 1.75 mL/min

Measurement time: 45 minutes

The content of the water-soluble polymer is preferably 0.001% by mass or more, more preferably 0.005% by mass or more, further preferably 0.01% by mass or more based on the total mass of the CMP polishing liquid. The content of the water-soluble polymer is preferably 15.0% by mass or less, more preferably 10.0% by mass or less, further preferably 5.0% by mass or less based on the total mass of the CMP polishing liquid from the viewpoint that the stability of the polishing particles contained in the CMP polishing liquid is sufficiently kept.

(Organic Solvent)

The CMP polishing liquid according to the present embodiment can further comprise an organic solvent. Thereby, the wettability of the CMP polishing liquid on the base such as substrates can be enhanced to increase the polishing rate of the barrier metal other than the ruthenium-based metal, or the like. Any organic solvent can be used without limitation; solvents which can be arbitrarily mixed with water are preferred.

Specific examples of the organic solvents include carbonate esters such as ethylene carbonate, propylene carbonate, dimethyl carbonate, diethyl carbonate, and methylethyl carbonate; lactones such as butyrolactone and propiolactone; glycols such as ethylene glycol, propylene glycol, diethylene glycol, dipropylene glycol, triethylene glycol, and tripropylene glycol; derivatives of glycols such as glycol monoethers such as ethylene glycol monomethyl ether, propylene glycol monomethyl ether, diethylene glycol monomethyl ether, dipropylene glycol monomethyl ether, triethylene glycol monomethyl ether, tripropylene glycol monomethyl ether, ethylene glycol monoethyl ether, propylene glycol monoethyl ether, diethylene glycol monoethyl ether, dipropylene glycol monoethyl ether, triethylene glycol monoethyl ether, tripropylene glycol monoethyl ether, ethylene glycol monopropyl ether, propylene glycol monopropyl ether, diethylene glycol monopropyl ether, dipropylene glycol monopropyl ether, triethylene glycol monopropyl ether, tripropylene glycol monopropyl ether, ethylene glycol monobutyl ether, propylene glycol monobutyl ether, diethylene glycol monobutyl ether, dipropylene glycol monobutyl ether, triethylene glycol monobutyl ether, and tripropylene glycol monobutyl ether, and glycol diethers such as ethylene glycol dimethyl ether, propylene glycol dimethyl ether, diethylene glycol dimethyl ether, dipropylene glycol dimethyl ether, triethylene glycol dimethyl ether, tripropylene glycol dimethyl ether, ethylene glycol diethyl ether, propylene glycol diethyl ether, diethylene glycol diethyl ether, dipropylene glycol diethyl ether, triethylene glycol diethyl ether, tripropylene glycol diethyl ether, ethylene glycol dipropyl ether, propylene glycol dipropyl ether, diethylene glycol dipropyl ether, dipropylene glycol dipropyl ether, triethylene glycol dipropyl ether, tripropylene glycol dipropyl ether, ethylene glycol dibutyl ether, propylene glycol dibutyl ether, diethylene glycol dibutyl ether, dipropylene glycol dibutyl ether, triethylene glycol dibutyl ether, and tripropylene glycol dibutyl ether; ethers such as tetrahydrofuran, dioxane, dimethoxyethane, poly(ethylene oxide), ethylene glycol monomethyl acetate, diethylene glycol monoethyl ether acetate, and propylene glycol monomethyl ether acetate; alcohols such as methanol, ethanol, propanol, n-butanol, n-pentanol, n-hexanol, and isopropanol; ketones such as acetone and methyl ethyl ketone; phenols; amides such as dimethyl formamide; n-methylpyrrolidone; ethyl acetate; ethyl lactate; and sulfolanes. Among these, carbonate esters, glycol monoethers, and alcohols are preferred. The organic solvent may be used singly or in combinations of two or more.

The content of the organic solvent is preferably 0.1% by mass or more, more preferably 0.2% by mass or more, further preferably 0.5% by mass or more based on the total mass of the CMP polishing liquid from the viewpoint that the wettability of the CMP polishing liquid on the base such as substrates is sufficiently ensured. The content of the organic solvent is preferably 50.0% by mass or less, more preferably 30.0% by mass or less, further preferably 10.0% by mass or less based on the total mass of the CMP polishing liquid from the viewpoint that dispersibility is sufficiently ensured.

(Surfactant)

The CMP polishing liquid according to the present embodiment can further comprise a surfactant. Examples of the surfactant include water-soluble anionic surfactants such as lauryl ammonium sulfate and polyoxyethylene lauryl ether ammonium sulfate; and water-soluble non-ionic surfactants such as polyoxyethylene lauryl ether and polyethylene glycol monostearate. Among these, water-soluble anionic surfactants are preferred as a surfactant. In particular, at least one water-soluble anionic surfactant such as polymer dispersants obtained by using ammonium salts as a copolymerizable component is more preferred. The water-soluble non-ionic surfactant, water-soluble anionic surfactant, water-soluble cationic surfactant, and the like may be used in combination. The content of the surfactant is, for example, 0.0001 to 0.1% by mass based on the total mass of the CMP polishing liquid.

(Water)

The CMP polishing liquid according to the present embodiment comprises water. The content of water in the CMP polishing liquid may be the rest other than the content of other constitutional components of the polishing liquid.

(pH of CMP Polishing Liquid)

The pH of the CMP polishing liquid according to the present embodiment is less than 7.0 from the viewpoint that the polishing rate of the ruthenium-based metal is increased by the electrostatic attracting action between the polishing particles and the ruthenium-based metal. The pH of the CMP polishing liquid is preferably 6.0 or less, more preferably 5.8 or less, further preferably 5.5 or less from the viewpoint that a higher polishing rate of the ruthenium-based metal is attained. The pH of the CMP polishing liquid is 3.0 or more from the viewpoint that the dishing of the wiring metal is prevented. The pH of the CMP polishing liquid is preferably 3.5 or more, more preferably 4.0 or more, further preferably 4.3 or more from the viewpoint that the dishing of the wiring metal is further prevented. Any known pH adjuster such as acids and bases can be used to adjust the pH. The pH is defined as a pH at a liquid temperature of 25° C.

The pH of the CMP polishing liquid can be measured with a pH meter (for example, manufactured by Denki Kagaku Keiki K.K., Model No. PHL-40). For example, the pH of the CMP polishing liquid can be measured by placing an electrode in the CMP polishing liquid and measuring a value stabilized after a lapse of 2 minutes or more at 25° C., after performing two-point calibration using standard buffer solutions (phthalate pH buffer, pH: 4.01 (25° C.); neutral phosphate pH buffer, pH: 6.86 (25° C.)).

The CMP polishing liquid according to the present embodiment can be stored, transported, and used in the form of a plurality of separate liquids of components forming the CMP polishing liquid. For example, the CMP polishing liquid according to the present embodiment may be separately stored as a component containing an oxidizing agent and constitutional components other than the oxidizing agent, or may be separately stored in the form of a first liquid and a second liquid, wherein the first liquid contains the polishing particles, the acid component, the triazole-based compound and the quaternary phosphonium salt, and the second liquid contains the oxidizing agent. The first liquid may further contain a metal solubilizing agent, a metal anti-corrosion agent, a water-soluble polymer, an organic solvent, a surfactant, and the like.

<Polishing Method>

Next, the polishing method according to the present embodiment will be described.

The polishing method according to the present embodiment comprises a polishing step of polishing a base having a ruthenium-based metal using the CMP polishing liquid to remove at least part of the ruthenium-based metal. In the polishing step, for example, the CMP polishing liquid is fed between the surface to be polished of the base having a ruthenium-based metal and a polishing pad (polishing cloth) to remove at least part of the ruthenium-based metal.

If the base has a ruthenium-based metal and a wiring metal and the ruthenium-based metal and the wiring metal are exposed on the surface to be polished of the base, the base may be polished using the CMP polishing liquid in the polishing step to remove at least part of the ruthenium-based metal and at least part of the wiring metal.

The base to be polished using the CMP polishing liquid is, for example, a base having a ruthenium-based metal and the wiring metal. The ruthenium-based metal is in the form of a layer (layer containing a ruthenium-based metal), for example. Examples of the base include substrates such as semiconductor substrates; parts such as parts for airplanes and automobiles; cars such as train cars; and housings for electronic apparatuses.

The polishing method according to the present embodiment may further comprise a step of forming a ruthenium-based metal on a base (first base) to prepare a base having a ruthenium-based metal (second base). As the method of forming a ruthenium-based metal, a method other than the PVD method is preferred, at least one method selected from the group consisting of CVD methods and ALD methods is more preferred, and a CVD method is further preferred. Thereby, if the microwiring (for example, wiring width: 15 nm or less) is formed, hollows generated in the wiring portion can be further prevented, and the ruthenium-based metal is readily removed at a favorable polishing rate if polished using the CMP polishing liquid according to the present embodiment. The polishing method according to the present embodiment can polish not only ruthenium-based metals formed by a method other than PVD method (such as CVD method or ALD method) but also ruthenium-based metals formed by PVD method at a favorable polishing rate.

Hereinafter, using an example in which the base is a semiconductor substrate, the polishing method according to the present embodiment will be described in detail. Examples using a ruthenium-based metal and the wiring metal, in the cases where the base is a semiconductor substrate, include a step of forming damascene wiring.

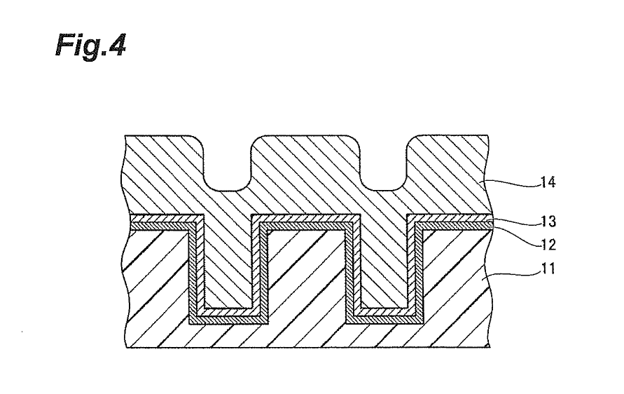

Examples include a method using a ruthenium-based metal as a seed layer instead of a copper seed layer, as illustrated in FIG. 4. In FIG. 4, reference sign 11 illustrates an insulating material, reference sign 12 illustrates a barrier metal, reference sign 13 illustrates a ruthenium-based metal, and reference sign 14 illustrates a wiring metal. The semiconductor substrate illustrated in FIG. 4 can be obtained, for example, by forming trench portions (depressed portions) on the surface of the insulating material 11, forming the barrier metal 12 on the insulating material 11 so as to follow the shape of the surface of the insulating material 11, then forming the ruthenium-based metal 13 on the barrier metal 12 so as to follow the shape of the barrier metal 12, and finally forming the wiring metal 14 on the ruthenium-based metal 13 so as to embed depressed portions and cover the entire surface thereof.

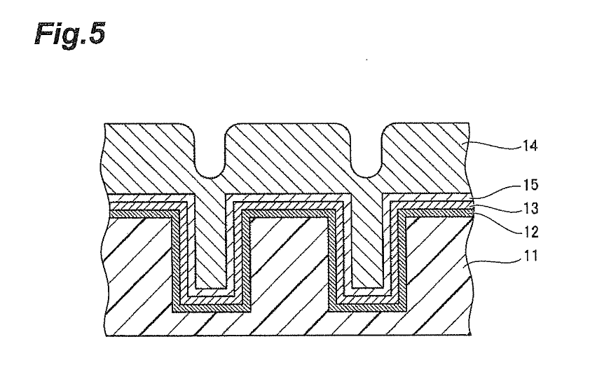

Moreover, examples include a method disposing a ruthenium-based metal 13 between a barrier metal 12 and a seed layer 15 using the same metal material as that for a wiring metal 14, as illustrated in FIG. 5. Namely, a step of forming the seed layer 15 using the same metal material as that for the wiring metal 14 is added after formation of the ruthenium-based metal 13 in FIG. 4 to obtain a semiconductor substrate having a structure illustrated in FIG. 5.

The wiring metal preferably contain copper-based metals such as copper, copper alloys, copper oxides, and copper alloy oxides. The wiring metal can be formed by a known method such as sputtering or plating.

Examples of the ruthenium-based metal include ruthenium, ruthenium alloys (such as alloys containing more than 50% by mass of ruthenium), and ruthenium compounds. Examples of the ruthenium alloys include ruthenium tantalum alloys and ruthenium titanium alloys. Examples of the ruthenium compounds include ruthenium nitride.

The barrier metal is formed to prevent diffusion of the wiring metal to the insulating material. Examples of the barrier metal include, but should not be limited to, tantalum-based metals such as tantalum, tantalum alloys, tantalum compounds (such as tantalum nitride); titanium-based metals such as titanium, titanium alloys, and titanium compounds (such as titanium nitride); and tungsten-based metals such as tungsten, tungsten alloys, and tungsten compounds (such as tungsten nitride).

Any insulating material which can reduce the parasitic capacitance between elements or between wirings and has insulation properties can be used without limitation; examples thereof include inorganic materials such as SiO₂, SiOF, and Si—H containing SiO₂; organic inorganic hybrid materials such as carbon-containing SiO₂ (SiOC) and methyl group-containing SiO₂; and organic polymer materials such as fluorinated resin-based polymers (such as PTFE-based polymers), polyimide-based polymers, poly(arylether)-based polymers, and parylene-based polymers.

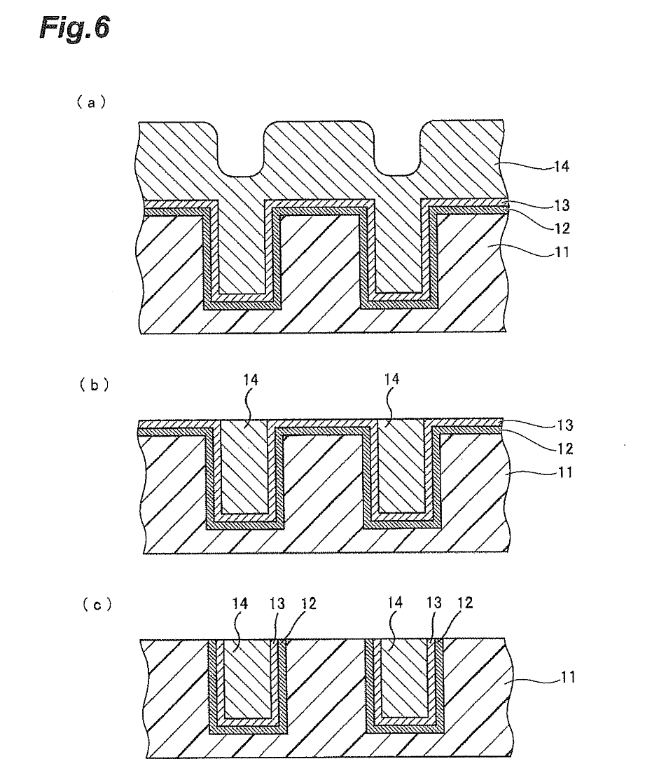

The step of polishing a base using the CMP polishing liquid according to the present embodiment will be described by way of FIG. 6. In FIG. 6, reference sign 11 illustrates an insulating material, reference sign 12 illustrates a barrier metal, reference sign 13 illustrates a ruthenium-based metal, and reference sign 14 illustrates a wiring metal. FIG. 6(a) is a cross-sectional view illustrating the state of a substrate before polishing, FIG. 6(b) is a cross-sectional view illustrating the state of the substrate after a first polishing step, and FIG. 6(c) is a cross-sectional view illustrating the state of the substrate after a second polishing step.

First, the wiring metal 14 is polished using a CMP polishing liquid for a wiring metal to expose the ruthenium-based metal 13 present on the projecting portions of the insulating material 11, to obtain a substrate having a structure illustrated in FIG. 6(b) (first polishing step). Next, the ruthenium-based metal 13 and the barrier metal 12 present on the projecting portions of the insulating material 11 and part of the wiring metal 14 present in depressed portions of the insulating material 11 are polished to expose the projecting portions of the insulating material 11, to obtain a substrate illustrated in FIG. 6(c) (second polishing step). Of these two polishing steps, it is preferred that the CMP polishing liquid according to the present embodiment be used at least in the second polishing step. Moreover, to enhance flatness, the polishing may be continued (overpolished) for a predetermined time after the insulating material 11 is exposed in the second polishing step. Namely, in the polishing step in the present embodiment, the base may be polished using the CMP polishing liquid to remove at least part of the ruthenium-based metal, at least part of the wiring metal, and at least part of the insulating material.

When the width of the wiring portion including the wiring metal is approximately 1 μm in the polishing step, the amount of dishing of the wiring portion (for example, the largest depth from the surface of the wiring portion) is preferably 30 nm or less, more preferably 20 nm or less. In such a polishing step, the CMP polishing liquid according to the present embodiment may be used in polishing in which the amount of dishing of the wiring portion having a width of 1 μm and including the wiring metal is 30 nm or less (preferably 20 nm or less). In the cases where the ruthenium-based metal and the wiring metal are exposed on the polished surface, the CMP polishing liquid according to the present embodiment may be used to polish the ruthenium-based metal and the wiring metal.

For example, a typical polishing apparatus having a platen to which a polishing pad can be attached and a holder for holding a substrate can be used as a polishing apparatus. A motor whose number of rotations can be varied or the like may be attached to the platen. Any polishing pad can be used without limitation; typical non-woven fabrics, foamed polyurethane, porous fluorinated resin, and the like can be used. Any polishing condition can be used without limitation; it is preferred that the rotational speed of the platen be adjusted to a low number of rotations of 200 min⁻¹ or less such that the substrate does not fall out of the platen.

The pressure applied to the substrate pressed against the polishing pad (polishing pressure) is preferably 4 to 100 kPa, more preferably 6 to 50 kPa from the viewpoint that high in-plane uniformity in the substrate and high flatness of the pattern are attained. By using the CMP polishing liquid according to the present embodiment, the ruthenium-based metal can be polished at a high polishing rate under a low polishing pressure. Attaining polishing at a low polishing pressure is preferred from the viewpoint that peel off, chipping, fragmentation, cracking, and the like of the polished material are prevented and high flatness of the pattern is attained.

It is preferred that the CMP polishing liquid be continuously fed to the polishing pad with a pump or the like during polishing. Any amount of the CMP polishing liquid can be fed without limitation; it is preferred that the surface of the polishing pad be always covered with the polishing liquid. After polishing is over, it is preferred that the substrate be sufficiently washed with running water, water droplets adhering to the substrate be shaken off using a spin dryer or the like, and the substrate be dried.

### EXAMPLES

Hereinafter, the present invention will be described in more detail by way of Examples, but the present invention will not be limited to these Examples without departing from the technical ideas of the present invention. For example, the type and the compounding ratio of the materials for the polishing liquid may be the type and the compounding ratio other than those described in Examples, and the composition and structure of the object to be polished may be the composition and the structure other than those described in Examples.

<Method of Preparing Polishing Liquid>

Polishing liquids were prepared using components shown in Tables 1 and Table 2 by the following method.

### Example 1

15.0 parts by mass of colloidal silica having an average secondary particle size of 60 nm and having a surface modified with a sulfo group, 0.4 parts by mass of phosphoric acid, 0.03 parts by mass of hydrogen peroxide, 3.0 parts by mass of 1,2,4-triazole, 0.005 parts by mass of tetraphenylphosphonium bromide and water were mixed, and then, the pH was adjusted to the value shown in Table 1 with aqueous ammonia to prepare 100 parts by mass of a CMP polishing liquid. The amounts of the colloidal silica, the phosphoric acid, and the hydrogen peroxide to be added were adjusted using a colloidal silica liquid containing 20% by mass of silica particles, an 85% by mass phosphoric acid aqueous solution, and a 30% by mass hydrogen peroxide solution.

### Examples 2 to 8 and Comparative Examples 1 to 5

Components shown in Table 1 were mixed, and the operation was performed in the same manner as in Example 1 to prepare CMP polishing liquids in Examples 2 to 8 and CMP polishing liquids in Comparative Examples 1 and 5. As anionic colloidal silica, colloidal silica having an average secondary particle size of 60 nm and having a surface modified with a sulfo group was used.

### Examples 9 to 18 and Comparative Examples 6 to 7

Components shown in Table 2 were mixed, and the operation was performed in the same manner as in Example 1 to prepare CMP polishing liquids in Examples 9 to 18 and CMP polishing liquids in Comparative Examples 6 to 7. As anionic colloidal silica, colloidal silica having an average secondary particle size of 60 nm and having a surface modified with a sulfo group was used.

<Evaluation on Properties of Polishing Liquids>

The zeta potential of the polishing particles in the CMP polishing liquid and the pH of the CMP polishing liquid were determined by the following procedures and conditions. The results of measurement are as shown in Table 1 and Table 2.

(Zeta Potential)

The zeta potential of the colloidal silica in the CMP polishing liquid was measured with “DELSA NANO C” manufactured by Beckman Coulter, Inc.

(pH)

Temperature for measurement: 25±5° C.

Measuring apparatus: manufactured by Denki Kagaku Keiki K.K., Model No. PHL-40

<Evaluation on Polishing Properties>

Examples 1 to 18 and Comparative Examples 1 to 7 were evaluated for the following items.

(1. Evaluation on Polishing of Ruthenium-Based Metal)

[Base to be Polished]

A ruthenium blanket substrate comprising a ruthenium film having a thickness of 15 nm (150 Å) formed on a silicon substrate by a CVD method was prepared.

A Cu blanket substrate comprising a copper film having a thickness of 1000 nm (10000 Å) formed on a silicon substrate by plating was prepared.

[Polishing of Base]

The bases to be polished were subjected to CMP using the CMP polishing liquids in Examples 1 to 18, and Comparative Examples 1 to 7 for 60 seconds under the following polishing conditions.

Polishing apparatus: polishing machine for one-sided metal film (manufactured by Applied Materials, Inc., Reflexion LK)

Polishing pad: polishing pad made of a foamed polyurethane resin

The number of rotations of platen: 123 min⁻¹

The number of rotations of head: 117 min⁻¹

Polishing pressure: 10.3 kPa (1.5 psi)

The amount of polishing liquid to be fed: 300 mL/min

[Washing of Base]

After a sponge brush (made of a poly(vinyl alcohol)-based resin) was pressed against the polished surface of the substrate polished above, the substrate was washed for 60 seconds by rotating the substrate and the sponge brush while feeding distilled water to the substrate. Next, after the sponge brush was removed, distilled water was fed to the polished surface of the substrate for 60 seconds. Finally, the substrate was rotated at a high speed to shake off distilled water from the substrate to dry the substrate.

[Evaluation on Polishing Rate]

The polishing rate was evaluated as follows. Based on the difference in film thickness before and after polishing measured with a metal film thickness measurement apparatus (product name: VR-120/08S) manufactured by Hitachi Kokusai Electric Inc., the polishing rates of the ruthenium blanket substrate and the Cu blanket substrate polished and washed under the above conditions were determined. The results of measurement are shown in Table 1 and Table 2 as “Ruthenium polishing rate” and “Cu polishing rate.”

(2. Evaluation on Influences on Wiring Metal)

(2-1. Evaluation on Amount of Etching of Copper)

While the CMP polishing liquid was being stirred (liquid temperature: 50° C., stirring rate: 200 min⁻¹), a substrate for measurement having a copper film formed thereon was immersed in the polishing liquid, and the difference in film thickness of the copper film before and after immersion was determined by conversion from the electric resistance value. From the difference in film thickness, the etching rate was determined. As the substrate for measurement, chips obtained by cutting the substrate (manufactured by Global Net Corp.) having a copper film having a thickness of 20 μm formed on the silicon substrate having a diameter of 8 inches (20 cm) (φ) size into 2 cm×2 cm were used. The amount of the CMP polishing liquid was 100 mL. The results of evaluation are shown in Table 1 and Table 2.

(2-2. Evaluation on Polishing Flaw)

The substrate after CMP (ruthenium blanket substrate in (1. Evaluation on polishing of ruthenium-based metal)) was observed visually and with an optical microscope and an electron microscope to verify the presence of the generation of polishing flaws. As a result, generation of remarkable polishing flaws was not found in all of Examples and Comparative Examples.

(2-3. Evaluation on Amount of Dishing of Wiring Metal)

[Preparation of Patterned Substrate (Base to be Polished)]

The following substrate was prepared as a base. A copper film other than depressed portions (trench portions) of a patterned substrate having a size of diameter of 12 inches (30.5 cm) (φ) with a copper wiring (manufactured by Advanced Materials Technology, Inc., SEMATECH 754 CMP pattern: interlayer insulation film made of silicon dioxide and having a thickness of 3000 Å: having a pattern of a copper wiring width of 1 μm and a wiring density of 50%) was polished using a polishing liquid for a copper film by a known CMP method to expose the barrier layer at projecting portions to the polished surface. The patterned substrate was cut into small pieces of 2 cm×2 cm, and was used in the following polishing The barrier layer of the patterned substrate was a PVD ruthenium film having a thickness of 300 Å and a PVD tantalum nitride film of 300 Å.

[Polishing of Base]

The bases to be polished were subjected to CMP using the CMP polishing liquids in Examples 1 to 18 and Comparative Examples 1 to 7 under the polishing conditions for 60 seconds.

[Evaluation on Dishing]

The dishing of the patterned substrates after polishing was evaluated under the following conditions. Namely, for the wiring metal portion having copper wiring width of 1 μm and wiring density of 50% in the patterned substrate after polishing, the reduced amount of the wiring metal portion relative to the insulation film portion was determined with a stylus type profilometer. The amount of dishing was evaluated based on the reduced amount. Cases where the amount of dishing was 20 nm or less were evaluated as the most preferable results, which were written as “A” in the tables. Cases where the amount of dishing was more than 20 nm and 30 nm or less were evaluated as preferred results, which were written as “B” in the tables. Cases where the amount of dishing was more than 30 nm were written as “C” in the tables. The results of evaluation are shown in Table 1 and Table 2.

TABLE 1

| | | Zeta | | | | |
|---|---|---|---|---|---|---|
| | | potential of | | | | |
| | Polishing | polishing | | Oxidizing | | |
| | particles | particles | Acid | agent | Anti-corrosion agent | |
| No. | (% by mass) | (mV) | (% by mass) | (% by mass) | (% by mass) | |
| Example 1 | Anionic colloidal | −25 | Phosphoric | Hydrogen | — | 1,2,4-Triazole |
| | silica (15.0) | | acid (0.4) | peroxide (0.03) | | (3.0) |
| Example 2 | Anionic colloidal | −20 | Phosphoric | Hydrogen | 5-Methyl(-1H-)benzotriazole | — |
| | silica (15.0) | | acid (0.4) | peroxide (0.03) | (0.5) | |
| Example 3 | Anionic colloidal | −20 | Phosphoric | Hydrogen | 5-Methyl(-1H-)benzotriazole | 1,2,4-Triazole |
| | silica (15.0) | | acid (0.4) | peroxide (0.03) | (0.5) | (3.0) |
| Example 4 | Anionic colloidal | −25 | Phosphoric | Hydrogen | Benzotriazole | — |
| | silica (15.0) | | acid (0.4) | peroxide (0.03) | (1.0) | |
| Example 5 | Anionic colloidal | −25 | Phosphoric | Hydrogen | 5-Methyl(-1H-)benzotriazole | 1,2,4-Triazole |
| | silica (15.0) | | acid (0.4) | peroxide (0.03) | (0.5) | (3.0) |
| Example 6 | Anionic colloidal | −28 | Phosphoric | Hydrogen | 5-Methyl(-1H-)benzotriazole | 1,2,4-Triazole |
| | silica (15.0) | | acid (0.4) | peroxide (0.03) | (0.5) | (3.0) |
| Example 7 | Anionic colloidal | −28 | Phosphoric | Hydrogen | 5-Methyl(-1H-)benzotriazole | 1,2,4-Triazole |
| | silica (15.0) | | acid (0.4) | peroxide (0.03) | (0.5) | (3.0) |
| Example 8 | Anionic colloidal | −20 | Nitric acid | Hydrogen | 5-Methyl(-1H-)benzotriazole | 1,2,4-Triazole |
| | silica (15.0) | | (0.4) | peroxide (0.03) | (0.5) | (3.0) |
| Comparative | Anionic colloidal | −10 | Phosphoric | Hydrogen | — | 1,2,4-Triazole |
| Example 1 | silica (15.0) | | acid (1.7) | peroxide (0.03) | | (3.0) |
| Comparative | Anionic colloidal | −21 | Phosphoric | Hydrogen | — | — |
| Example 2 | silica (15.0) | | acid (1.7) | peroxide (0.03) | | |
| Comparative | Anionic colloidal | −25 | Phosphoric | Hydrogen | 5-Methyl(-1H-)benzotriazole | 1,2,4-Triazole |
| Example 3 | silica (15.0) | | acid (0.4) | peroxide (0.03) | (0.5) | (3.0) |
| Comparative | Anionic colloidal | −21 | Malic acid | Hydrogen | 5-Methyl(-1H-)benzotriazole | 1,2,4-Triazole |
| Example 4 | silica (15.0) | | (0.4) | peroxide (0.03) | (0.3) | (30) |
| Comparative | Anionic colloidal | −20 | Phosphoric | Hydrogen | 5-Methyl(-1H-)benzotriazole | 1,2,4-Triazole |
| Example 5 | silica (15.0) | | acid (0.4) | peroxide (0.03) | (0.5) | (3.0) |

| | | | | Cu | Cu | |
|---|---|---|---|---|---|---|
| | Quaternary phosphonium | | Ruthenium | polishing | etching | |
| | salt | | polishing rate | rate | rate | |
| No. | (% by mass) | pH | (Å/min) | (Å/min) | (Å/min) | Dishing |
| Example 1 | Tetraphenylphosphonium | 5.0 | 43 | 280 | 65 | B |
| | bromide (0.005) | | | | | |
| Example 2 | Tetraphenylphosphonium | 4.0 | 50 | 300 | 70 | B |
| | bromide (0.005) | | | | | |
| Example 3 | Tetraphenylphosphonium | 4.0 | 52 | 300 | 60 | B |
| | bromide (0.005) | | | | | |
| Example 4 | Tetraphenylphosphonium | 5.0 | 37 | 270 | 80 | B |
| | bromide (0.005) | | | | | |
| Example 5 | Tetraphenylphosphonium | 5.0 | 47 | 250 | 45 | A |
| | bromide (0.005) | | | | | |
| Example 6 | Tetraphenylphosphonium | 6.0 | 40 | 220 | 25 | A |
| | bromide (0.005) | | | | | |
| Example 7 | Tetraphenylphosphonium | 6.0 | 40 | 200 | 40 | A |
| | bromide (0.01) | | | | | |
| Example 8 | Tetraphenylphosphonium | 4.0 | 35 | 270 | 50 | B |
| | bromide (0.005) | | | | | |
| Comparative | Tetraphenylphosphonium | 2.5 | 110 | 1440 | 700 | C |
| Example 1 | bromide (0.005) | | | | | |
| Comparative | Tetraphenylphosphonium | 4.0 | 80 | 1200 | 600 | C |
| Example 2 | bromide (0.005) | | | | | |
| Comparative | Tetraphenylphosphonium | 7.0 | 15 | 100 | 10 | A |
| Example 3 | bromide (0.005) | | | | | |
| Comparative | Tetraphenylphosphonium | 4.0 | 10 | 200 | 50 | B |
| Example 4 | bromide (0.005) | | | | | |
| Comparative | — | 4.0 | 50 | 430 | 100 | C |
| Example 5 | | | | | | |

TABLE 2

| | | Zeta | | | | |
|---|---|---|---|---|---|---|
| | | potential of | | | | |
| | Polishing | polishing | | | | |
| | particles | particles | Acid | Oxidizing agent | Anti-corrosion agent | |
| No. | (% by mass) | (mV) | (% by mass) | (% by mass) | (% by mass) | |
| Example 9 | Anionic colloidal | −25 | Glycolic acid | Hydrogen | 5-Methyl(-1H-)benzotriazole | 1,2,4-Triazole |
| | silica (15.0) | | (0.4) | peroxide (0.03) | (0.5) | (3.0) |
| Example 10 | Anionic colloidal | −25 | Lactic acid | Hydrogen | 5-Methyl(-1H-)benzotriazole | 1,2,4-Triazole |
| | silica (15.0) | | (0.4) | peroxide (0.03) | (0.5) | (3.0) |
| Example 11 | Anionic colloidal | −25 | Fumaric | Hydrogen | 5-Methyl(-1H-)benzotriazole | 1,2,4-Triazole |
| | silica (15.0) | | acid (0.4) | peroxide (0.03) | (0.5) | (3.0) |
| Example 12 | Anionic colloidal | −25 | Itaconic acid | Hydrogen | 5-Methyl(-1H-)benzotriazole | 1,2,4-Triazole |
| | silica (15.0) | | (0.4) | peroxide (0.03) | (0.5) | (3.0) |
| Example 13 | Anionic colloidal | −25 | Maleic acid | Hydrogen | 5-Methyl(-1H-)benzotriazole | 1,2,4-Triazole |
| | silica (15.0) | | (0.4) | peroxide (0.03) | (0.5) | (3.0) |
| Example 14 | Anionic colloidal | −25 | Glycine | Hydrogen | 5-Methyl(-1H-)benzotriazole | 1,2,4-Triazole |
| | silica (15.0) | | (0.4) | peroxide (0.03) | (0.5) | (3.0) |
| Example 15 | Anionic colloidal | −25 | Alanine | Hydrogen | 5-Methyl(-1H-)benzotriazole | 1,2,4-Triazole |
| | silica (15.0) | | (0.4) | peroxide (0.03) | (0.5) | (3.0) |
| Example 16 | Anionic colloidal | −25 | Salicylic acid | Hydrogen | 5-Methyl(-1H-)benzotriazole | 1,2,4-Triazole |
| | silica (15.0) | | (0.4) | peroxide (0.03) | (0.5) | (3.0) |
| Example 17 | Anionic colloidal | −25 | Propionic | Hydrogen | 5-Methyl(-1H-)benzotriazole | 1,2,4-Triazole |
| | silica (15.0) | | acid (0.4) | peroxide (0.03) | (0.5) | (3.0) |
| Example 18 | Anionic colloidal | −25 | Acetic acid | Hydrogen | 5-Methyl(-1H-)benzotriazole | 1,2,4-Triazole |
| | silica (15.0) | | (0.4) | peroxide (0.03) | (0.5) | (3.0) |
| Comparative | Anionic colloidal | −25 | Citric acid | Hydrogen | 5-Methyl(-1H-)benzotriazole | 1,2,4-Triazole |
| Example 6 | silica (15.0) | | (0.4) | peroxide (0.03) | (0.5) | (3.0) |
| Comparative | Anionic colloidal | −25 | Tartaric acid | Hydrogen | 5-Methyl(-1H-)benzotriazole | 1,2,4-Triazole |
| Example 7 | silica (15.0) | | (0.4) | peroxide (0.03) | (0.5) | (3.0) |

| | | | Ruthenium | Cu | Cu | |
|---|---|---|---|---|---|---|
| | Quaternary phosphonium | | polishing | polishing | etching | |
| | salt | | rate | rate | rate | |
| No. | (% by mass) | pH | (Å/min) | (Å/min) | (Å/min) | Dishing |
| Example 9 | Tetraphenylphosphonium | 4.0 | 35 | 220 | 40 | B |
| | bromide (0.005) | | | | | |
| Example 10 | Tetraphenylphosphonium | 4.0 | 40 | 240 | 50 | B |
| | bromide (0.005) | | | | | |
| Example 11 | Tetraphenylphosphonium | 4.0 | 41 | 250 | 45 | B |
| | bromide (0.005) | | | | | |
| Example 12 | Tetraphenylphosphonium | 4.0 | 35 | 280 | 40 | B |
| | bromide (0.005) | | | | | |
| Example 13 | Tetraphenylphosphonium | 4.0 | 40 | 270 | 40 | B |
| | bromide (0.005) | | | | | |
| Example 14 | Tetraphenylphosphonium | 4.0 | 42 | 330 | 45 | B |
| | bromide (0.005) | | | | | |
| Example 15 | Tetraphenylphosphonium | 4.0 | 48 | 310 | 45 | B |
| | bromide (0.005) | | | | | |
| Example 16 | Tetraphenylphosphonium | 4.0 | 42 | 250 | 50 | B |
| | bromide (0.005) | | | | | |
| Example 17 | Tetraphenylphosphonium | 4.0 | 47 | 280 | 50 | B |
| | bromide (0.005) | | | | | |
| Example 18 | Tetraphenylphosphonium | 4.0 | 50 | 290 | 55 | B |
| | bromide (0.005) | | | | | |
| Comparative | Tetraphenylphosphonium | 4.0 | 15 | 250 | 70 | B |
| Example 6 | bromide (0.005) | | | | | |
| Comparative | Tetraphenylphosphonium | 4.0 | 13 | 300 | 100 | B |
| Example 7 | bromide (0.005) | | | | | |

Hereinafter, the results shown in Table 1 and Table 2 will be described in detail. Examples 1 to 18 show the results of evaluation on the polishing rate of ruthenium, the Cu polishing rate, the Cu etching rate, and the amount dishing of polishing liquids comprising one or two of triazole-based compounds selected from 5-methyl(-1H-)benzotriazole, 1,2,4-triazole, and benzotriazole and the quaternary phosphonium salt. From these results, it turns out that the polishing rate of ruthenium is kept high, and the Cu polishing rate and the Cu etching rate are suppressed to reduce the amount of dishing, when the polishing liquids comprise the triazole-based compound and the quaternary phosphonium salt.

Examples 3, 5, and 6 show the results of evaluation in the cases where the pH was varied. From these results of evaluation, it turns out that the amount of dishing can be reduced while the polishing rate of ruthenium is kept high when the pH is adjusted to 3.0 or more and less than 7.0.

In Examples 6 and 7, the content of the quaternary phosphonium salt is varied. In both cases, the Cu etching rate is reduced, and the Cu etching rate is further reduced at a content of the quaternary phosphonium salt of 0.005% by mass.

Examples 3 and 8 show the results of evaluation in the cases where phosphoric acid and nitric acid were used as the acid component, respectively. In both cases, the polishing rate of ruthenium is favorable.

Examples 9 to 18 show the results of evaluation in the cases where a variety of acid components specified in the present application were used. In each case, the polishing rate of ruthenium is favorable.

From the results of Comparative Example 1, it turns out that, at a pH of 2.5, the Cu polishing rate and the Cu etching rate are high, and the amount of dishing is large. From the results of Comparative Example 2, it turns out that, when the polishing liquid does not comprise the triazole-based compound, the Cu polishing rate and the Cu etching rate are high, and the amount of dishing is large. From the results of Comparative Example 3, it turns out that, at a pH of 7.0, the polishing rate of ruthenium is low. From the results of Comparative Examples 4, 6, and 7, it turns out that the polishing rate of ruthenium is low when the acid component specified in the present application is not used. From the results of Comparative Example 5, it turns out that the Cu polishing rate and the Cu etching rate are high, and the amount of dishing is large when the polishing liquid does not comprise the quaternary phosphonium salt.

### INDUSTRIAL APPLICABILITY

The present invention can increase the polishing rate of the ruthenium-based metal and can prevent the dishing of the wiring metal, compared to the cases where the conventional CMP polishing liquid is used.

### REFERENCE SIGNS LIST

1, 11 . . . insulating material, 2 . . . trench portions (depressed portions), 3, 14 . . . wiring metal, 4, 12 . . . barrier metal, 5, 15 . . . seed layer, 6 . . . metal (barrier metal or seed layer), 7 . . . hollows (voids), 13 . . . ruthenium-based metal.

1. A CMP polishing liquid for polishing a ruthenium-based metal, comprising:
polishing particles;
an acid component;
an oxidizing agent;
a triazole-based compound;
a quaternary phosphonium salt; and
water,
wherein the acid component contains at least one selected from the group consisting of inorganic acids, monocarboxylic acids, carboxylic acids having a plurality of carboxyl groups and having no hydroxyl group, and salts thereof,
the polishing particles have a negative zeta potential in the CMP polishing liquid, and
a pH of the CMP polishing liquid is 3.0 or more and less than 7.0.

2. The CMP polishing liquid according to claim 1, wherein the triazole-based compound contains a compound represented by the following general formula (I): 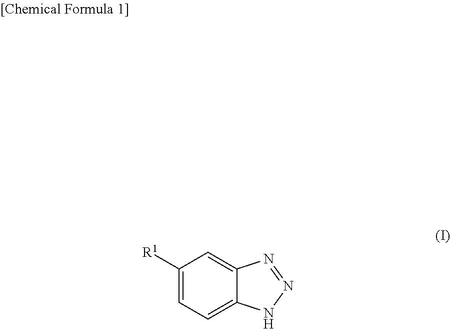
[In formula (I), R¹ represents a hydrogen atom or an alkyl group having 1 to 3 carbon atoms.]

3. The CMP polishing liquid according to claim 1, wherein the triazole-based compound contains 1,2,4-triazole.

4. The CMP polishing liquid according to claim 1, wherein the acid component contains at least one selected from the group consisting of nitric acid, phosphoric acid, glycolic acid, lactic acid, glycine, alanine, salicylic acid, acetic acid, propionic acid, fumaric acid, itaconic acid, maleic acid, and salts thereof.

5. The CMP polishing liquid according to claim 1, wherein the quaternary phosphonium salt contains at least one selected from the group consisting of triaryl phosphonium salts and tetraaryl phosphonium salts.

6. The CMP polishing liquid according to claim 1, wherein the quaternary phosphonium salt contains a compound represented by the following general formula (II): 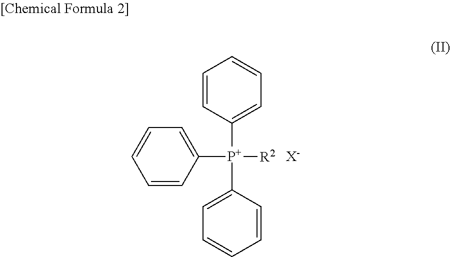
[In formula (II), benzene rings each may have a substituent; R² represents an optionally substituted alkyl group or aryl group; and X⁻ represents an anion.]

7. The CMP polishing liquid according to claim 1 for polishing a ruthenium-based metal and a wiring metal.

8. The CMP polishing liquid according to claim 7 for polishing in which an amount of dishing of a wiring portion having a width of 1 μm and including the wiring metal is 30 nm or less.

9. The CMP polishing liquid according to claim 1,
wherein the CMP polishing liquid is separately stored in a form of a first liquid and a second liquid,
the first liquid contains the polishing particles, the acid component, the triazole-based compound and the quaternary phosphonium salt, and
the second liquid contains the oxidizing agent.

10. A polishing method, comprising a polishing step of polishing a base having a ruthenium-based metal using the CMP polishing liquid according to claim 1 to remove at least part of the ruthenium-based metal.

11. The polishing method according to claim 10, wherein the base further has a wiring metal, and in the polishing step, at least part of the ruthenium-based metal and at least part of the wiring metal are removed.

12. The polishing method according to claim 11, wherein the wiring metal is a copper-based metal.

13. The polishing method according to claim 10, further comprising a step of forming a ruthenium-based metal on a base by a formation method other than a physical vapor deposition method to prepare a base having a ruthenium-based metal.

14. The polishing method according to claim 13, wherein the formation method is at least one selected from the group consisting of chemical vapor deposition methods and atomic layer deposition methods.
